(19) United States
(12) Patent Application Publication
(10) Pub. No.: US 2005/0254643 A1
(43) Pub. Date: Nov. 17, 2005

(54) Universal phone cover and method of use

(76) Inventors: Tanya G. Hall, Studio City, CA (US); James G. Dahlgren, Los Angeles, CA (US)

Correspondence Address: LAW OFFICES OF DAVID L. HOFFMAN, 27023 MCBEAN PKWY, SUITE 422, VALENCIA, CA, 91355, US

(21) Appl. No.: 10/847,701

(22) Filed: May 17, 2004

(51) Int. Cl. H04M 1/00

(52) U.S. Cl. 379/452

(57) ABSTRACT

A cover for a telephone handset is made of a nonwoven fabric folded in half and stitched around its edges, an elasticized band formed in a loop and fixed to the fabric, the elasticized band defining a sole opening in the fabric, and the material has a crescent shape when folded. A preferred method of covering a telephone handset with a cover having an opening formed therein with an elastic band defining the opening, includes the steps of: (i) placing a first hand inside the cover; (ii) grasping a handle of the handset with the first hand while inside the cover; (iii) pulling one end of the cover over one of an earpiece and a mouthpiece of the handset by partially inverting the cover using a second hand; and (iv) pulling a second end of the cover over the other of the earpiece and mouthpiece of the handset by partially inverting the cover with one of the first and second hands, while holding the handset handle with the other of the first and second hands.

### BACKGROUND OF THE INVENTION

1. Field of the Invention

The present invention in a preferred embodiment relates to a telephone handset cover which is loose fitting and a method for covering the handset with the cover without touching the handset.

2. Description of the Related Art

It has long been desirable to prevent or minimize the transmission of germs from one person to another. Well over one hundred years ago, it was discovered that medical personnel could carry germs from one patient to another on their hands. Accordingly, health care workers, especially doctors, always wash their hands with germicidal substances before examining or treating each patient.

In more recent years, it has become standard practice to use disposable gloves, masks, and the like, to prevent contamination of the patient, and also to protect the health care worker from receiving the patient's infectious diseases, especially HIV which causes the illness commonly known as AIDS. Even dentists now typically wear disposable gloves. Such gloves worn by health care workers are form-fitting.

Transmission of diseases is also a concern of the general public. Bathrooms contain disposable seat covers in the shape of the seat. Thermometers now are often sold with disposable form-fitting covers.

For some time now disposable covers have been proposed for telephone handsets, particularly for the mouthpiece and earpiece, and even for the handle. All or virtually all of these covers are form fitting. Form fitting covers are difficult to make universal, difficult to put on without touching the phone, and may even be difficult to remove without touching the phone. If a cover cannot be put on without touching the handset, and/or if it cannot be removed without touching the handset or touching a portion of the cover that has touched the handset, then the value of the cover is vitiated. For example, severe acute respiratory syndrome (“SARS”), is caused by a virus spread through mucous or saliva and can live outside the body for between 24 and 48 hours. Therefore, after a SARS victim uses the phone, any droplets of human fluid on the handset can have live SARS virus. The live virus would be transferable to the next phone user, even a day or two later.

An example of a form fitting phone cover is disclosed in U.S. Pat. No. 4,819,265 to Colella. It is impregnated with a germicidal composition. It has two adhesive surfaces to connect the cover together after fitting on the handset. It has an aperture for the phone cord. It has perforated surfaces for the earpiece and mouthpiece. These covers, even if they cover the entire handset, are form fitting and therefore their use is limited. Moreover, users must possess great dexterity, skill and/or luck to apply the cover without touching the handset. Further, the holes at the earpiece and mouthpiece can allow germ transmission.

U.S. Pat. No. 5,862,215 to Gariette discloses relatively loose fitting individual covers, one for just the mouthpiece and one for just the earpiece. The handle is not covered leaving a major portion of the handset unprotected. Moreover, it may still require some skill to put the covers on the earpiece and mouthpiece without touching them.

Other patents include Des. 364,171 to Maddack et al. showing a telephone receiver sleeve, which appears to be of a woven material and has a large opening, Des. 372,920 to Bragg et al. also having a large opening for the receiver, and U.S. Patent Appln. Publ. No. 2003/0012371 A1 to Weinstock et al. on a “phone sock” having an elongated oval opening and requiring a slit from the opening to accommodate the phone card.

What is needed is a simple to manufacture, inexpensive phone cover that is universal or substantially universal, easy to use without touching the phone or cord, and not dependent on a germicide, which increases cost, may not be fully effective and/or may harm the user.

### SUMMARY OF THE INVENTION

In one embodiment, an inventive phone cover is universal, substantially symmetrical, and is relatively loose fitting over the handset. The cover is preferably banana-shaped or crescent shaped. Preferably, it has no flaps, and no hook and loop or other fasteners.

The material is preferably a biologically impervious material such as that used for surgical masks, surgical booties, and the like.

The cover has an elongated opening smaller than the length between the top and bottom of a typical phone handset, and the opening is defined preferably by an elastic band or other elasticized element sewn in or to a border of the cover defining the opening. Preferably, the cover is otherwise closed.

In accordance with a preferred embodiment of an inventive method for using the cover, a user inserts one hand into the cover through the hole, then grasps the handle of the phone with that hand. With the other hand, the user pulls the cover from inside the opening near or at one end of the opening and turns that end inside out while pulling that end over the earpiece (or the mouthpiece, whichever is closest to that end). Then the user takes the cover at the opposite end of the opening (with respect to the length of the opening) and turns that end inside out while pulling it over the mouthpiece (or earpiece if the mouthpiece was covered first). The hand that was inside the cover grasping the handle of the handset may be released or may continue to hold the handle for use. The cover is now over the entire handset, and the user has not touched the handset. When on the handset, the opening becomes closed or substantially closed due to the elastic band. Sound is not noticeably hindered or distorted by the material. After one-time use, the cover is preferably discarded.

### BRIEF DESCRIPTION OF THE DRAWINGS

FIG. 1 is a side elevational view of a cover in accordance with an embodiment of the invention;

FIG. 2 is a top view of the cover of FIG. 1;

FIG. 3 is a side perspective view of a user carrying out a step in accordance with an embodiment of a method of covering a telephone handset in accordance with the invention, e.g., using the cover of FIG. 1;

FIG. 4 is a view similar to FIG. 3 in accordance with another step in the method of FIG. 3;

FIG. 5 is a view similar to FIG. 3 in accordance with a further step in the method of FIG. 3;

FIG. 6 is a partial cutaway side view of the cover of FIG. 1 with an elastic band therein in its extended position for purposes of explaining assembly of the cover; and

FIG. 7 is a side elevational view of a cover in accordance with a second embodiment of the invention.

### DESCRIPTION OF THE PREFERRED EMBODIMENT(S)

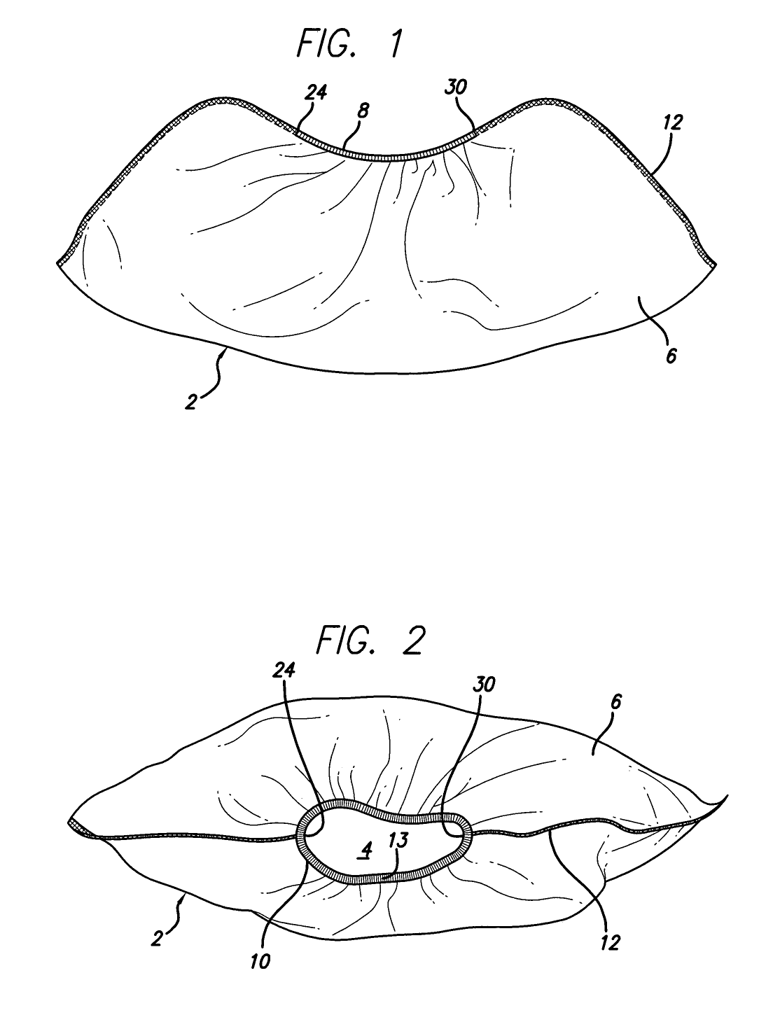

A telephone handset cover in accordance with one embodiment of the invention is shown in FIGS. 1 and 2. Generally, the cover is banana-shaped or crescent moon shaped. It is preferably made of a biologically impervious or protective material such as that used for surgical masks, surgical booties, and the like. This material is preferably a nonwoven, microporous or “breathable” polymer such as polypropylene, e.g., spundbonded polypropylene. It is impervious to biological fluids for up to four to six hours. Such a material has already been FDA approved. Like surgical masks, such a cover is intended for one time use.

More specifically, the nonwoven material is preferably impervious to bodily fluids for at least 2 hours, more preferably at least 4 hours, and more preferably at least about six hours. Such nonwoven materials are well known in the art. They are often used for disposable medical garments such as booties. Examples of nonwoven materials include Tyvek® fabric, a spundbonded polyolefin available from E.I. DuPont de Nemours, and Company, Wilmington, Del. and Cuturon® material by FiberMark of Brattleboro, Vt. Nonwoven material can be made out of a variety of synthetics including but not limited to polypropylene, polyurethane and/or polyolefin.

The thickness of the material may be comparable to typical surgical booties. It may be dictated so as to achieve a desired minimum imperviousness to bodily fluid. Determination of such thickness is well known in the art.

Cover 2 has an opening 4. The material 6 forming cover 2 has an opening 4 defined therein. This opening is bordered by an elastic band 8 which is fixed to the material 6. Preferably, material 6 is folded over the band and stitched to hold the band in place. A fold 10 with stitching 13 is shown in FIG. 2. Other than opening 4, cover 2 is preferably closed. In the rest state of elastic band 8, opening 4 is also preferably closed or substantially closed.

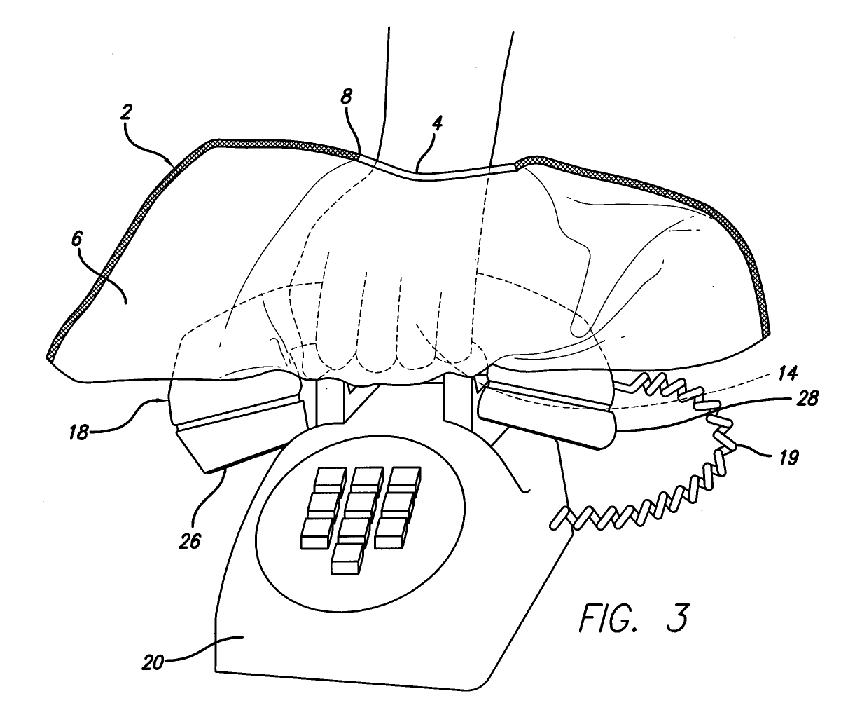

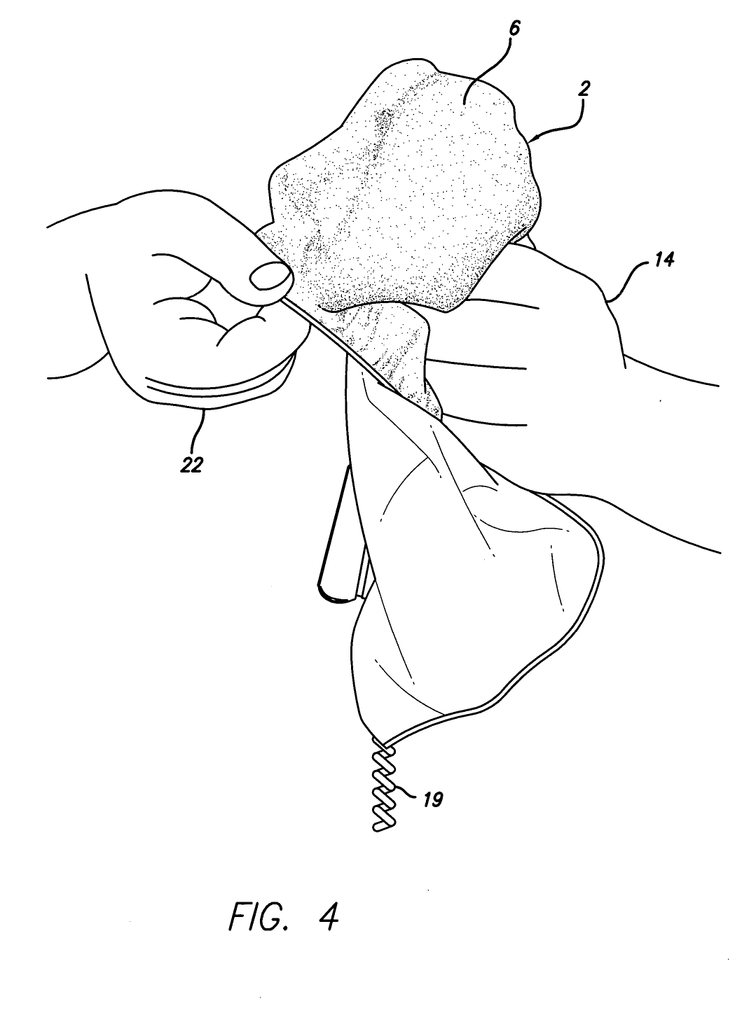

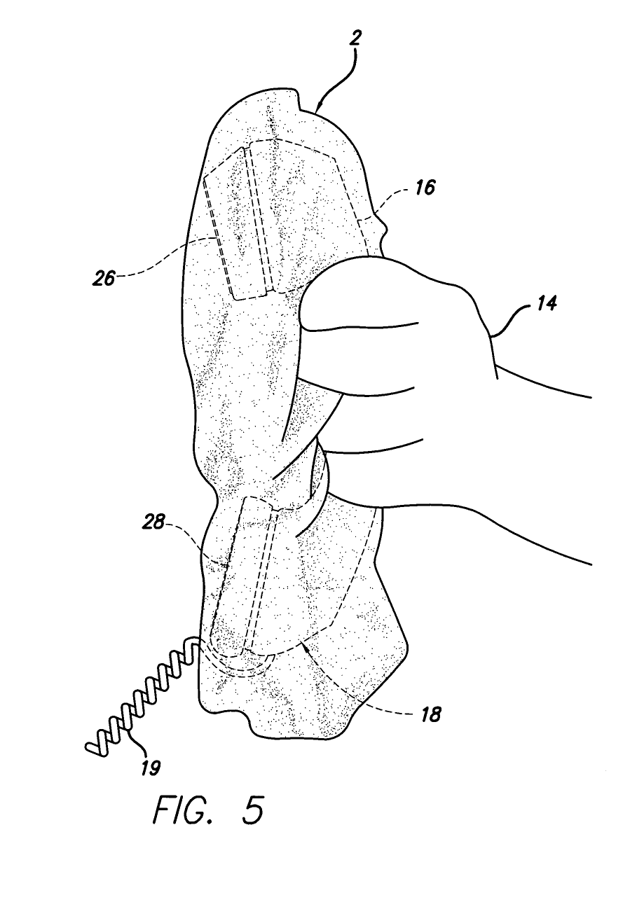

Cover 2 is sized to fit loosely over a typical telephone handset. As shown in FIGS. 3 through 5, the telephone cover is placed on a telephone handset using a method according to another preferred embodiment of invention. With reference to FIG. 3, a user places one hand 14 such as the left-hand, through the opening 4 in the cover. As shown in FIG. 4, the user then grasps the handle (labeled 16 in FIG. 5) of a handset 18 on phone 20 with hand 14 covered by cover 2. As also shown in FIG. 4, the user then takes his or her other hand 22, in this case the right hand, and pulls the elastic band from an endpoint 24 (see FIGS. 1 and 2) of opening 4 over an earpiece 26 of a handset. This is done by placing hand 22 or at least one or more fingers of hand 22 into the opening 4 and turning the cover 2 inside out to cover the earpiece 26. To cover mouthpiece 28 of handset 16, the user applies the same technique using the same hand 22. Specifically, the user will reach hand 22 (or at least one or more fingers of the hand) inside the opening 4 at or near opposite endpoint 30, then pull that portion of the cover over mouthpiece 28, turning that portion of the cover inside out.

At this point, as best shown in FIG. 5, the cover is completely inside out and covering or substantially covering the entire handset. The user may then use the handset by lifting with the hand 14 already holding the handle 16. Of course, the user could switch to the other hand at this point, or at any point in the process, but this is the simplest way to implement a process in accordance with this embodiment of the invention.

Using this process, the user has not touched the phone or handset at any time. The preferred material, while biologically impervious, allows the passage of sound in an undistorted or substantially undistorted manner. Accordingly, there need not be any holes in the material for the earpiece or mouthpiece. There is nothing to align with the earpiece or mouthpiece. Users can cover the handset easily.

The cover may readily be removed by essentially a reverse process. The user continues holding the handle. The user uses the other hand 22 to pull the cover off of the earpiece and mouthpiece. However, the user need not grab the material through the opening to do this. Rather, the user can simply grab the portion of the material covering the earpiece and the portion of the material covering the mouthpiece to remove it. The cover may then be discarded. In this way, the user has never had to touch the phone or receiver. Yet, this process can be followed by even those with limited dexterity.

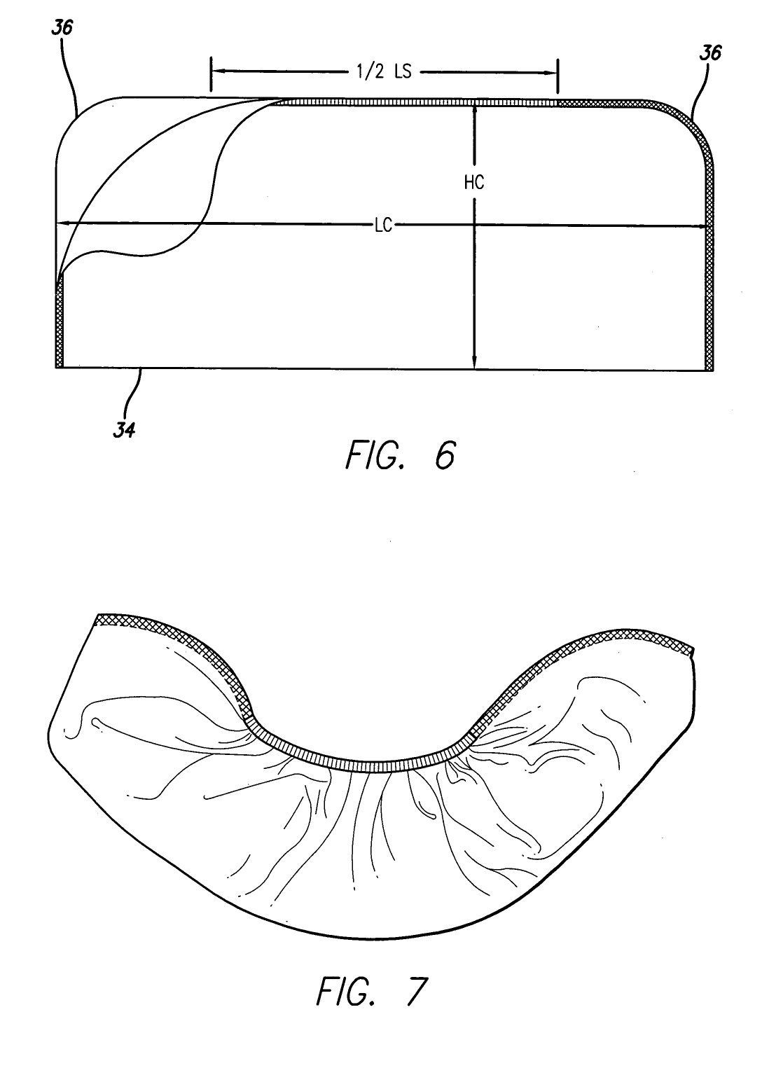

The cover in accordance with the preferred embodiment and in accordance with a preferred method, is also easy to manufacture. For example, as shown in FIG. 6, the material may be cut into a substantially rectangular piece having a first dimension of twice the desired height HC of the cover. The second dimension of the material corresponds to the desired length LC of the cover. Length LC is preferably longer than the length of typical handsets, which are usually roughly six to nine inches. Height HC is preferably longer than one half of the sum of the circumference of typical handsets.

As also shown in FIG. 6, the edges of rectangular piece 34 are preferably curved as represented by rounded corners 36. Elastic band 8 is centered along a folded edge of the material 34 and the material is preferably folded back over the elastic band. This process is preferably performed with the elastic band in a stretched or substantially fully stretched state. Thus, if the circumference of the stretched band is LS, then the length of material 34 where band 8 is positioned is one half the stretched band circumference, i.e., ½ LS. The remainder of the material is stitched around the folded edges to close off the material (see stitching 12 in FIG. 1). When the stretched band is relaxed, the material to which it is stitched is folded over itself, such as shown in FIGS. 1 and 2.

The relaxed circumference of the elastic band is preferably relatively small so as to leave only a very small portion of the phone uncovered and also so as to be relatively secure around the user's hand during the process of covering the handset, but easily stretchable so that the user can put a hand inside the cover and can still grab an endpoint of the elastic band to stretch over the mouthpiece or earpiece.

Although other dimensions may work, suitable (approximate) dimensions for the cover, with reference to FIG. 6, may be as follows:

| Dimension | Preferred | More Preferred | Most Preferred |
|---|---|---|---|
| LC | 7″-15″ | 9″-13″ | 11″ |
| HC | 4″-8″ | 5″-7″ | 5″ |
| ½ LS (stretched) | 6″-12″ | 8″-10″ | 8″ |
| ½ LS (unstretched) | 2 ½″-6 ½″ | 3 ½″-5 ½″ | 4 ½″ |

In the preferred embodiment, twice height HC is preferably greater than and most preferably substantially greater than the largest circumference of a typical handset, and preferably one-half of LS is longer than one-half the length of the typical handset and most preferably substantially longer. This is because the elastic band must be sufficient to go around the user's wrist while holding the handle which would be lower than the midpoint of the handset and extend over the top of the handset. In other words, the extended length of the elastic band must be greater than approximately the thickness of the user's wrist plus the width of the user's wrist plus the length of the handset plus the greater of the earpiece's width plus thickness or the mouthpiece's width plus thickness. One-half of the at rest circumference of the band preferably is less than the distance between the earpiece and mouthpiece so that the opening (though closed or substantially closed) is not adjacent the ear or mouth of the user during use.

The cover may have a small opening at or near one edge to accommodate an antenna from a cordless phone.

FIG. 7 is a side elevational view of a cover in accordance with a second embodiment of the invention. It is constructed essentially the same as the embodiment of FIG. 1 but with a more pronounced angle of its banana shape.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

1. A cover for a telephone handset, comprising:
a nonwoven fabric material folded in half and stitched around edges thereof;
an elasticized member formed in a loop and fixed to said fabric material;
the elasticized member defining a sole opening in the fabric material;
the material having a crescent shape when folded.

2. The cover of claim 1, wherein the opening can fit a user's hand therethrough.

3. The cover of claim 1, wherein the opening is substantially closed when the elastic is at rest in an unstretched state and the elastic band is at least about five inches around, and at least about ten inches around in a fully stretched state.

4. The cover of claim 1, wherein the cover is of a size such that a telephone handset of at least eight inches long can fit completely therein.

5. The cover of claim 4 wherein the material does not distort human voice sound.

6. A method of covering a telephone handset with a cover having an opening formed therein with elastic therearound, the method comprising the steps of:
(i) placing a first hand inside the cover;
(ii) grasping a handle of the handset with the first hand while inside the cover;
(iii) pulling one end of the cover over one of an earpiece and a mouthpiece of the handset by partially inverting the cover using a second hand; and
(iv) pulling a second end of the cover over the other of the earpiece and mouthpiece of the handset by partially inverting the cover with one of the first and second hands, while holding the handset handle with the other of the first and second hands.

7. The method of claim 6, after the step of pulling the second end of the cover, the cover has been fully inverted.

8. The method of claim 6, wherein the steps (i) through (iv) occur sequentially in order.

9. The method of claim 6, wherein the cover further comprises a nonwoven material forming a closed cover, except for the opening defined therein, and wherein in the step of grasping the handle, the handle is grasped while the handset is on the phone.

10. The method of claim 6, wherein in the step of pulling one end over the earpiece or mouthpiece, the elastic band is stretched thereover while the first hand continues to grasp the handle through the cover.

11. The method of claim 10, wherein in the step of pulling the second end of the cover over the earpiece or mouthpiece, the elastic band is stretched thereover while the first hand continues to grasp the handle through the cover.

12. The method of claim 6, wherein after the step of pulling the second end of the cover, the handset is covered by the cover, with the elastic band being returned substantially to its rest position such that the opening is substantially closed.

13. The method of claim 12, wherein after the step of pulling the second end of the cover, the earpiece and mouthpiece are loosely covered by the cover.

14. The method of claim 13, wherein after the step of pulling the second end of the cover, the elastic band is disposed between the earpiece and mouthpiece.

15. The method of claim 14, wherein after the step of pulling the second end of the cover, the handset is covered by the cover, with the elastic band being returned substantially to its rest position, such that the opening is substantially closed.

16. The method of claim 6, wherein the cover is on the handset while a user talks on the phone, then the cover is discarded after replacing the handset on the phone.

17. The method of claim 6, further comprising a step of talking on the phone using the cover, listening through the cover and speaking through the cover.

18. The method of claim 17, wherein the cover is removed by pulling the cover off of the earpiece and the mouthpiece with one of said hands while holding the handle with the other of said hands, and placing the handset on the phone still holding the handle through the cover.

19. A combination of a telephone handset and a cover, the cover comprising:
a nonwoven fabric material folded in half and stitched around edges thereof;
an elasticized member formed in a loop and fixed to said fabric material;
the elasticized member defining a sole opening in the fabric material;
the material having a crescent shape when folded.

20. The combination of claim 19, wherein the handset loosely fits within the cover when covered such that the handset is movable within the cover, and the elastic band is disposed between an earpiece and a mouthpiece of the handset.
